(19) United States
(12) Patent Application Publication
(10) Pub. No.: US 2024/0143394 A1
(43) Pub. Date: May 2, 2024

(54) HETEROGENEOUS COMPUTING TERMINAL FOR TASK SCHEDULING

(71) Applicant: Shanghai Makesens Energy StorageTechnology Co, Ltd., Shanghai (CN)

(72) Inventors: Jian ZHAO, Shanghai (CN); Yan MA, Shanghai (CN); Pei SONG, Shanghai (CN); Guopeng ZHOU, Shanghai (CN); Zonglin CAI, Shanghai (CN); Xiao YAN, Shanghai (CN); Enhai ZHAO, Shanghai (CN); Xiaohua CHEN, Shanghai (CN)

(73) Assignee: Shanghai Makesens Energy Storage Technology Co, Ltd., Shanghai (CN)

(21) Appl. No.: 18/490,795

(22) Filed: Oct. 20, 2023

(30) Foreign Application Priority Data
Nov. 1, 2022 (CN) 202211355598.7

(51) Int. Cl. G06F 9/48

(52) U.S. Cl. CPC G06F 9/4881

(57) ABSTRACT

A heterogeneous computing terminal for task scheduling is provided, including a processing unit and multiple computing units. The heterogeneous computing terminal generates a task scheduling strategy. The target computing unit acquires a target upgrade program, is upgrade based on the target upgrade program, processes a target task and sends a processing result to the processing unit. The processing unit combines processing results sent by multiple target computing units to obtain a processing result of an initial task set. The heterogeneous computing terminal can upgrade the computing unit online, that is, dynamically update the computing unit, thereby greatly expanding the versatility of the computing unit of hardware. Scheduling strategy adapted to the task can be generated, and the computing unit can dynamically provide better task processing capabilities. The computing efficiency of the heterogeneous computing terminal is improved. Further, processing capability and processing efficiency are better when facing complex tasks.

### CROSS-REFERENCE TO RELATED APPLICATION

This application claims priority to Chinese Patent Application No. 202211355598.7, filed on Nov. 1, 2022, which is incorporated herein by its reference in its entirety.

### FIELD

The present application relates to the technical field of edge computing, and in particular to a heterogeneous computing terminal for task scheduling.

### BACKGROUND

Various subdivided application scenarios are emerging with the development of industry and the Internet of Things industry. In scenarios with high latency requirements, edge computing becomes an important solution to meet this requirement. However, a single edge computing processor has limited capabilities. The cost of improving the processing capability of the single edge computing processor is relatively high, which is not cost-effective to process a large amount of data in a single scenario, and is difficult to meet the low-latency data processing requirements of computing-intensive applications.

### SUMMARY

In order to solve the existing technical problems, a heterogeneous computing terminal for task scheduling is provided according to an embodiment of the present application.

A heterogeneous computing terminal for task scheduling is provided according to an embodiment of the present application. The heterogeneous computing terminal includes a processing unit and multiple computing units.

The heterogeneous computing terminal is configured to acquire an initial task set including at least one initial task, and generate a task scheduling strategy based on a currently pending task. The currently pending task is a task to be processed at a current moment, and at an initial moment the initial task is the currently pending task. The task scheduling strategy includes a correspondence between the currently pending task and a target computing unit, and the target computing unit is a computing unit for processing the initial task set.

The target computing unit is configured to acquire a target upgrade program corresponding to the currently pending task that has the correspondence with the target computing unit from a preset database, and to be upgrade based on the target upgrade program. For each of the multiple computing units, the database includes an upgrade program corresponding to the computing unit. The computing unit corresponds to multiple upgrade programs each corresponding to a category of tasks that the computing unit is to process.

The target computing unit is further configured to acquire a target task to be processed, process the target task after the upgrade, and send a corresponding processing result to the processing unit.

The processing unit is configured to combine processing results sent by multiple target computing units to obtain a processing result of the initial task set.

In an embodiment, the generation of the task scheduling strategy based on the currently pending task includes:
establishing a correspondence between currently pending tasks equal in number to current target computing units and the current target computing units based on an optimal matching algorithm, in a case that the number of the currently pending tasks is greater than or equal to the number of the current target computing units.

The current target computing unit is a target computing unit that is idle at the current moment and has no correspondence with any currently pending task.

In an embodiment, the generation of the task scheduling strategy based on the currently pending task includes:
establishing a correspondence between currently pending tasks and current target computing units repeatedly until the number of the currently pending tasks is greater than or equal to the number of the current target computing units, in a case that the number of the currently pending tasks is less than the number of the current target computing units, where the current target computing unit is a target computing unit that is idle at the current moment and has no correspondence with any of the currently pending tasks; and
establishing the correspondence between the currently pending tasks equal in number to the current target computing units and the current target computing units based on an optimal matching algorithm,
where the establishing a correspondence between currently pending tasks and current target computing units includes:
establishing the correspondence between all the currently pending tasks and the current target computing units equal in number to all currently pending tasks.

In an embodiment, the generation of the task scheduling strategy based on the currently pending task includes:
establishing a correspondence between the currently pending task and each current target computing unit in a case that the currently pending task is 1 in number, where the current target computing unit is a target computing unit that is idle at the current moment and has no correspondence with any currently pending task.

In an embodiment, the generation of the task scheduling strategy based on the currently pending task includes:
in a case that the multiple target computing units correspond to the same currently pending task, dividing the currently pending task into subtasks equal in number to the multiple target computing units, where the subtask is the target task to be processed by the corresponding target computing unit.

In an embodiment, the division of the currently pending task into subtasks equal in number to the multiple target computing units includes:
optimizing performance parameters of the multiple target computing units, where the optimized performance parameters have a higher degree of discrimination than the unoptimized performance parameters;
determining performance values of the multiple target computing units with the optimized performance parameters of the target computing units as an input of a performance function model, where the performance function model represents a functional relationship between the performance parameter of the computing unit and the performance value of the computing unit;
normalizing the performance values of the multiple target computing units to determine weights of the multiple target computing units; and
dividing the currently pending task into subtasks equal to the number of the multiple target computing units based on the weights, where processing amount of the subtask has a positive correlation with the corresponding weight.

In an embodiment, the heterogeneous computing terminal is further configured to: determine a part of a currently unfinished task in other target computing unit as a newly target task of the target computing unit after finishing processing the assigned target task.

The currently unfinished task is a task that has not been processed among target tasks processed by the other target computing unit at the current moment.

In an embodiment, the determination of the part of the currently unfinished task in another target computing unit as the newly target task of the target computing unit includes:
normalizing performance values of the other target computing unit and n target computing units that have finished processing to determine weights of the other target computing unit and the n target computing units; and
dividing the currently unfinished task into n+1 subtasks based on the weights of the other target computing unit and the n target computing units, as newly target tasks of the target computing units that have finished processing, where processing amount of the subtask has a positive correlation with the corresponding weight.

In an embodiment, the target computing unit is further configured to: determine whether the target upgrade program is to be solidified; write the target upgrade program into a storage unit of the target computing unit if the target upgrade program is to be solidified; and write the target upgrade program into a memory of the target computing unit if the target upgrade program is not to be solidified.

In an embodiment, the heterogeneous computing terminal is further configured to send an interrupt signal to the target computing unit when receiving a task change instruction for changing the initial task set.

The target computing unit is further configured to still process the target task until part or all of the target task is completely processed, and send a processing completion signal.

The heterogeneous computing terminal is further configured to newly generate a task scheduling strategy in response to the processing completion signal.

According to the heterogeneous computing terminal in the embodiments of the present application, various upgrade programs for processing correspondingly category of tasks can be preset for the computing unit. The upgrade program is matched to the category of tasks to be processed. In order to process the initial task set, the heterogeneous computing terminal generates a task scheduling strategy, and assigns the target tasks to be processed to the corresponding target computing units. The target computing unit can be upgraded based on the corresponding target upgrading program, so that the upgraded target computing unit can process the assigned target tasks, thereby achieving task scheduling and processing. The heterogeneous computing terminal can upgrade the computing unit online, that is, dynamically update the computing unit, thereby greatly expanding the versatility of the computing unit of the hardware.

Scheduling strategy adapted to the task can be generated, and the computing unit can dynamically provide better task processing capabilities. In this way, the computing efficiency of the heterogeneous computing terminal is improved, and the heterogeneous computing terminal is suitable for scenarios with high latency requirements. Further, the heterogeneous computing terminal also has better processing capability and processing efficiency when facing complex tasks.

### BRIEF DESCRIPTION OF THE DRAWINGS

In order to more clearly illustrate the technical solutions in the embodiments of the present application or the conventional technology, the drawings to be used in the embodiments of the present application or the conventional technology are described below.

FIG. 1 is a schematic structural diagram illustrating a heterogeneous computing system;

FIG. 2 is a diagram illustrating a flowchart heterogeneous computing terminal according to an embodiment of the present application;

FIG. 3 is a diagram illustrating a flowchart of the heterogeneous computing terminal according to an embodiment of the present application in detail; and

FIG. 4 is a schematic flowchart of generating a task scheduling strategy by the heterogeneous computing terminal according to an embodiment of the present application.

### DETAILED DESCRIPTION

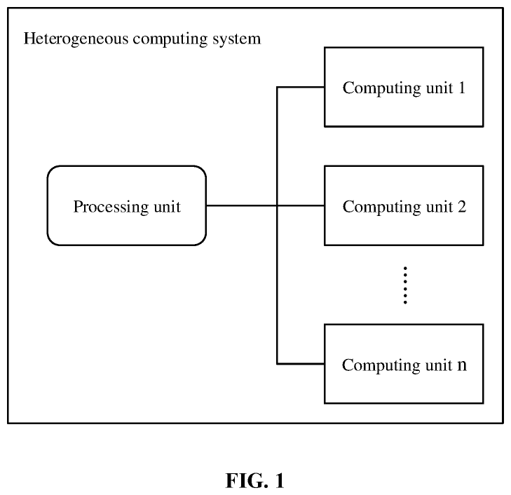

Heterogeneous computing systems are more suitable for scenarios with high latency requirements due to their high utilization of computing resources. The heterogeneous computing system is a data processing system. Referring to FIG. 1, the heterogeneous computing system includes a processing unit and various computing units. The processing unit may be a central processing unit (CPU), a data processing unit (DPU), or the like. The computing unit may be a programmable integrated circuit (IC) of a field programmable gate array (FPGA), a partially programmable IC, an application specific IC (ASIC) or the like. The processing unit interacts with the computing unit through a transmission interface. The computing unit is architecturally distinct from the processing unit. The computing unit offloads the computing power of the processing unit, and use the computing result for the processing unit.

However, the computing unit in the traditional heterogeneous computing system is only suitable for processing some tasks, the scheduling strategy is relatively simple, and the processing ability and processing efficiency for complex data are weak. According to an embodiment of the present application, a heterogeneous computing terminal based on the heterogeneous computing system is provided. That is, the heterogeneous computing terminal also includes a processing unit and multiple computing units. The heterogeneous computing terminal utilizes an upgrade program to improve the versatility of the computing unit, so that the scheduling strategy adapted to the task can be generated. Therefore, the heterogeneous computing terminal has better processing capabilities and processing efficiency for various data.

For the convenience of description, the concepts involved in the embodiments of the present application are explained firstly as follows.
(1) Task: is a computer terminology. The desired result can be obtained by processing this task. For example, the task is to calculate a power value, and the processing result obtained by processing the task is the corresponding power value.
(2) Initial task: a task that are assigned to the heterogeneous computing terminal and to be processed by the heterogeneous computing terminal.
(3) Initial task set: a set containing all the initial tasks. The initial task set may include one initial task or multiple initial tasks, depending on the actual situation.
(4) Currently pending task: a task that is to be processed at the current moment. At the moment when the initial task is obtained, the initial task is also a currently pending task. In other words, the initial value of the currently pending task is the initial task.
(5) Subtask: a part of a complete task. The initial task and the currently pending task are generally complete tasks. Correspondingly, the subtask may be part of the initial task or the currently pending task.
(6) Target task: a task that is assigned to the corresponding target computing unit and is to be processed by the target computing unit. The target task may be a currently pending task (complete task), or a part of a currently pending task, for example, a subtask of the currently pending task.
(7) Currently unfinished task: a task among the target tasks processed by the target computing unit that has not been processed at the current moment. The currently unfinished task is also a subtask of the target task. For example, a target task assigned to a target computing unit contains 100 sets of data to be processed. If at the current moment, the target computing unit has processed 40 sets of data, the remaining 60 sets of data are the currently unfinished task corresponding to the target computing unit at the current moment.
(8) Target computing unit: a computing unit to process the initial task set in the heterogeneous computing terminal. For example, when the heterogeneous computing terminal acquires the initial task set, all currently idle computing units may serve as target computing units. The number of target computing units may be one or more.
(9) Current target computing unit: a target computing unit that is idle at the current moment and does not establish a correspondence with any currently pending task. Those skilled in the art can understand that at the current moment, if a certain target computing unit A is a current target computing unit. After the correspondence between the target computing unit A and a task to be processed is established, the target computing unit A is no longer a current target computing unit. In addition, if a task to be processed currently has a correspondence with a target computing unit, the task is still the currently pending task as long as the target computing unit has not processed the task.
(10) Target computing unit that has been processed: a target computing unit that has processed all target tasks previously assigned to itself. The target computing unit is idle after processing all target tasks assigned to it. In this case, the target computing unit may assist other target computing units to process corresponding tasks. The target computing unit that has been processed may also be regarded as the current target computing unit.

Embodiments of the present application are described below with reference to the drawings in the embodiments of the present application. It should be understood that the embodiments described here are only used to illustrate and explain the embodiments of the present application, and are not intended to limit the embodiments of the present application.

A heterogeneous computing terminal is provided according to an embodiment of the present application. The heterogeneous computing terminal has the same architecture as the existing mature heterogeneous computing system. The heterogeneous computing terminal also includes a processing unit and a computing unit as shown in FIG. 1. The number of computing units is multiple. For example, the heterogeneous computing terminal may be an edge computing terminal, that is, for edge computing.

The heterogeneous computing terminal is configured to acquire an initial task set including at least one initial task, and generate a task scheduling strategy based on a currently pending task. The currently pending task is a task to be processed at a current moment. At an initial moment, the initial task is the currently pending task. The task scheduling strategy includes a correspondence between the currently pending task and a target computing unit. The target computing unit is a computing unit for processing the initial task set.

The target computing unit is configured to acquire a target upgrade program corresponding to the currently pending task that corresponds to the target computing unit stored in a preset database, and is upgraded based on the target upgrade program. The database includes upgrade programs for each of the computing units. The computing unit corresponds to multiple upgrade programs. Each of the upgrade programs corresponds to a category of task processable by the computing unit. The target computing unit is further configured to acquire a target task to be processed, process the target task after upgrading, and send a processing result to the processing unit. The target task is a task assigned to the corresponding target computing unit.

The processing unit is configured to combines processing results sent by the multiple target computing units, to obtain a processing result of the initial task set.

In an embodiment of the present application, the heterogeneous computing terminal includes multiple computing units. For a task set (that is, the initial task set) to be processed, some (or all) of the computing units serve as target computing units capable of processing the task set. The tasks in the task set are processed by all target computing units. The heterogeneous computing terminal may generate a corresponding task scheduling strategy, so as to assign tasks to corresponding target computing units. The task scheduling strategy may be generated by the processing unit. Alternatively, the heterogeneous computing terminal may also include a task scheduling system, and the task scheduling strategy is generated by the task scheduling system, so that the target computing units are scheduled.

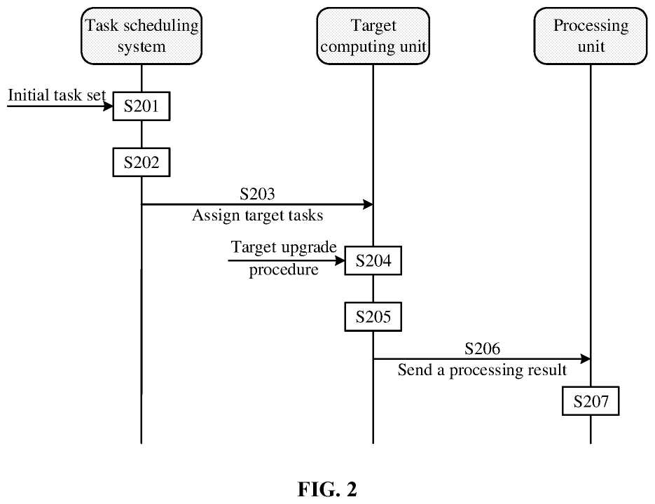

In one example, the task scheduling strategy is generated by the task scheduling system. Referring to FIG. 2, the operation of the heterogeneous computing terminal specifically includes the following steps S201 to S207.

In step S201, the task scheduling system acquires an initial task set including at least one initial task.

In step S202, the task scheduling system generates a task scheduling strategy.

In the embodiment of the present application, at the initial moment when the initial task set is acquired (that is, the initial moment is the moment when the initial task set is acquired), the task scheduling strategy may be generated once. The task scheduling strategy for this initial task set will not be changed or modified afterwards. That is, the task scheduling system may generate the task scheduling strategy based on the initial task set.

Alternatively, since the initial task set includes multiple initial tasks and different computing units may have different processing efficiencies, the task scheduling strategy may be updated in real time based on the tasks to be processed currently at different moments. Specifically, in the embodiment of the present application, the task to be processed at the current moment is referred to as “currently pending task”. At different moments, the aforementioned “current moment” is also different. Moreover, at different current moments, corresponding task scheduling policies may be generated based on all currently pending tasks. For example, at the initial moment when the initial task set is acquired, that is, the current moment, none of the initial tasks in the initial task set has been processed by the computing unit. All initial tasks are tasks to be processed, and therefore are currently pending tasks. Therefore, at the initial moment, the corresponding task scheduling strategy is generated based on all the initial tasks (that is, the initial task set) (this process is the same as the above one-time generation of the task scheduling strategy). At a moment after the initial moment, the corresponding task scheduling strategy may be generated if there is a currently pending task at this moment.

In the embodiment of the present application, it is determined which computing units are to process the initial task set, that is, which computing units are target computing units before the task scheduling strategy is generated. For example, at the initial moment, all currently idle computing units are determined as target computing units, or the target computing units are designated by the heterogeneous computing terminal, which is not limited herein.

After the target computing units are determined, the task scheduling strategy for allocating tasks to the target computing unit is generated. In the embodiment of the present application, the task scheduling strategy includes at least the correspondence between the currently pending tasks and the target computing units. Correspondingly, part or all of the currently pending tasks may be assigned to corresponding target computing units, for the target computing units to process the corresponding task. In general, one computing unit only processes one task. Therefore, in the embodiment of the present application, one target computing unit corresponds to one currently pending task. However, one currently pending task may correspond to multiple target computing units, that is, one currently pending task may be divided into multiple tasks (i.e., subtasks) to be processed by respective target computing units. Therefore, there may be a one-to-one correspondence or a one-to-many correspondence between the currently pending task and the target computing unit, depending on actual conditions.

In step S203, the task scheduling system assigns, based on the task scheduling strategy, the target tasks to be processed by the target computing units to the corresponding target computing units.

In the embodiment of the present application, each target computing unit is assigned a corresponding target task based on the correspondence between the currently pending task and the target computing unit. The target tasks may be all the corresponding currently pending tasks, or a part of the corresponding currently pending tasks. For example, if there is a one-to-one correspondence between the currently pending tasks and the target computing units, all the currently pending tasks may be assigned to the corresponding target computing units. Alternatively, if there is a many-to-one correspondence between the currently pending task and the target computing unit, a part of the currently pending task may be assigned to the corresponding target computing unit.

Those skilled in the art should understand that the above steps S201 to S203 may also be performed by the processing unit. In the embodiment of the present application, steps S201 to S203 are performed by the task scheduling system as an example for illustration.

In step S204, the target computing unit acquires the corresponding target upgrade program in the database based on the target task to be processed.

The traditional computing unit has a single function. However, in the embodiment of the present application, multiple upgrade programs are pre-set for each computing unit. Each upgrade program is for processing a corresponding category of tasks. For example, the upgrade program may include an algorithm program for rapidly processing this category of tasks. In the embodiment of the present application, the upgrade programs for all the computing units in the heterogeneous computing terminal are stored in the database. In order to process a category of tasks, the computing unit is upgraded based on a corresponding upgrade program, so as to process this category of tasks. Depending on the upgrade program, this computing unit is able to process various categories of tasks. The computing unit may be upgraded and performs computation at any time, and therefore has versatility. In the case of complex tasks, the processing resources of the computing unit can also be fully utilized to realize intelligent scheduling and processing of various complex tasks.

Specifically, the target computing unit acquires from the database the upgrade program corresponding to the currently pending task having a correspondence with the target computing unit, that is, the target upgrade program. As shown in the above step S204, the target computing unit acquires the corresponding target upgrade program in the database based on the target task to be processed. The target computing unit may actively acquire the target upgrade program from the database, or the task scheduling system writes the target upgrade program into the target computing unit, that is, the target computing unit passively receives the target upgrade program, which is not limited herein. In different solutions, the target tasks may be assigned to the target computing unit at different moments. In the embodiment of the present application, the target task is assigned to the target computing unit first, and then the target computing unit is upgraded.

Optionally, the target computing unit is also configured to determine whether the target upgrade program is to be solidified. If the target upgrade program is to be solidified, the target computing unit writes the target upgrade program into a storage unit of the target computing unit. If the target upgrade program is not to be solidified, the target computing unit writes the target upgrade program into a memory of the target computing unit, e.g., the RAM (random access memory). In the embodiment of the present application, if the target computing unit is to process a category of tasks for a long time, for example, the amount of the target task is relatively large, it may be considered to solidify the target upgrade program, that is, to write the target upgrade program into the storage unit of the target computing unit. In this case, more algorithm cores may be assigned to the target computing unit of the solidified upgrade program so as to improve processing efficiency. Specifically, in addition to some configurations, the upgrade program also includes the corresponding algorithm core. The algorithm core refers to the computation module that optimizes a given algorithm based on the characteristics of the computing unit (such as data precision, data structure, and framework design), and is a module that can greatly speed up the computation speed of the algorithm. Different task categories correspond to different algorithm cores. The algorithm core can speed up the processing of this category of tasks. The advantage of solidification is that more algorithm cores can be deployed in the target computing unit (for the reason is that the storage unit has a larger storage space, while RAM has a relatively small storage space since limited by factors such as price and stability). The solidification is generally suitable for the computing unit that is not frequently upgraded in a short period of time.

In step S205, the target computing unit is upgraded based on the target upgrade program, and processes the target task after the upgrade.

After acquiring the target upgrade program, the target computing unit is upgraded based on the target upgrade program, so that the upgraded target computing unit can process the corresponding target task. Optionally, when the target computing unit cannot process the currently pending task corresponding to the target computing unit (that is, when the target computing unit cannot process the assigned target task), the above step S204 is performed. On the contrary, if the target computing unit can currently process the target task, for example, the upgrade program currently used by the target computing unit is the target upgrade program, the target computing unit neither acquire the target upgrade program repeatedly nor is upgrade repeatedly.

In step S206, the target computing unit sends the corresponding processing result to the processing unit.

In step S207, the processing unit combines the processing results sent by the multiple target computing units to obtain the processing result for the initial task set.

In the embodiment of the present application, each target computing unit sends the processing result to the processing unit after finishing processing the corresponding target task. The processing unit combines the processing results from all the target computing units to obtain the final processing result, that is, the processing result for the initial task set. After receiving the processing result, the processing unit may perform task verification first and then combine all the processing results after the verification. Moreover, the processing unit may transmit the processing result of the initial task set to a corresponding database for storage. The database may be the database storing the upgrade programs corresponding to the computing units or another database, which is not limited herein.

According to the heterogeneous computing terminal in the embodiments of the present application, various upgrade programs for processing correspondingly category of tasks can be preset for the computing unit. The upgrade program is matched to the category of tasks to be processed. In order to process the initial task set, the heterogeneous computing terminal generates a task scheduling strategy, and assigns the target tasks to be processed to the corresponding target computing units. The target computing unit can be upgraded based on the corresponding target upgrading program, so that the upgraded target computing unit can process the assigned target tasks, thereby achieving task scheduling and processing. The heterogeneous computing terminal can upgrade the computing unit online, that is, dynamically update the computing unit, thereby greatly expanding the versatility of the computing unit of the hardware. Different scheduling strategies can be generated for different tasks, and the computing unit can dynamically provide better task processing capabilities. In this way, the computing efficiency of the heterogeneous computing terminal is improved, and the heterogeneous computing terminal is suitable for scenarios with high latency requirements. Further, the heterogeneous computing terminal also has better processing capability and processing efficiency when facing complex tasks.

Optionally, the currently pending task itself has corresponding features. For example, the currently pending task is an initial task, and the features of the initial task include: the number of initial tasks, the category of each initial task, the priority of each initial task and the like. A corresponding task scheduling strategy may be generated based on the features of the currently pending task itself, for example, a correspondence between the currently pending task and the target computing unit is generated.

In the embodiment of the present application, the computing unit can generally only process one task at a moment. Therefore, the computing unit corresponds to one task only. The number of currently pending tasks affects the task scheduling strategy. For example, the number of initial tasks in the initial task set is variable. Different initial task sets may include different numbers of initial tasks. The correspondence between the initial tasks and the target computing units is based on the number of initial tasks.

Moreover, in order to make full use of the processing resources of the computing unit, if there is an idle target computing unit at the current moment and there are still tasks that the target computing unit can process (for example, the initial task set has not been fully processed at the current moment), a task is assigned to the idle target computing unit, for example, a correspondence between the idle target computing unit and a task is established. In the embodiment of the present application, if a target computing unit is not currently processing a task at the current moment, the target computing unit is idle. If a correspondence between the target computing unit and a currently pending task has been established at the current moment, the target computing unit subsequently processes all or part of the currently pending task as a target task. In this case, no correspondence is established for the target computing unit. On the contrary, if the target computing unit is idle and has no correspondence with any currently pending task, the target computing unit is in a task waiting state. A correspondence between the target computing unit and a currently pending task is established. For convenience of description, in the embodiments of the present application, a target computing unit that is idle at the current moment and has no correspondence with any currently pending task is referred to as a “current target computing unit”.

Specifically, the “generating a task scheduling strategy based on the currently pending task” performed by the heterogeneous computing terminal may include the following step A1.

In step A1, when the number of currently pending tasks is greater than or equal to the number of current target computing units, a correspondence between the currently pending tasks equal in number to the current target computing units and the current target computing units is established based on an optimal matching algorithm. The current target computing unit is a target computing unit that is idle at the current moment and has not established a correspondence with any of the currently pending tasks.

In the embodiment of the application, if the number of currently pending tasks is greater than or equal to the number of current target computing units, that is, the number of tasks to be processed is not less than the number of available target computing units, all current target computing units are assigned complete currently pending tasks in the embodiment of the application since one target computing unit can only process one task at a moment. Specifically, based on the optimal matching algorithm, currently pending tasks equal in number to current target computing units are selected from all the currently pending tasks. The selected currently pending tasks are assigned to corresponding current target computing units. Each selected currently pending task corresponds to a unique current target computing unit. Correspondingly, the target task assigned to the current target computing unit is a complete currently pending task corresponding to the current target computing unit. The optimal matching algorithm may be an auction algorithm, etc., which is not limited herein.

For example, the number of currently pending tasks is M, and the number of current target computing units is N. If M=N, the one-to-one correspondence between the currently pending task and the current target computing unit can be directly established based on the optimal matching algorithm. If M>N, N tasks may be selected from the M currently pending tasks based on the optimal matching algorithm. The N currently pending tasks are assigned to the N current target computing units respectively. There is a one-to-one correspondence between the N currently pending tasks and the N current target computing units. In this case, there are still M−N currently pending tasks for which no correspondence has been established. Since the previous N current target computing units have already established correspondence with respective tasks, and therefore are no longer in the waiting state. That is, there is no current target computing unit in this case (the number of current target computing units is zero). It is necessary to wait for the newly emerged current target computing unit to process the remaining M-N currently pending tasks.

For example, at the initial moment, the currently pending task is the initial task, and the current target computing unit is the determined target computing unit for processing the initial task set. If the number of initial tasks is greater than or equal to the number of target computing units, a correspondence between the initial tasks and the target computing units is established based on step A1. If the number M of initial tasks is greater than the number N of target computing units, the remaining M-N initial tasks are processed after some target computing units finish the processing.

Optionally, the “generating a task scheduling strategy based on the currently pending task” performed by the heterogeneous computing terminal may include the following steps B1 to B2.

In step B1, when the number of currently pending tasks is less than the number of the current target computing units, the process of establishing the correspondence between the currently pending task and the current target computing unit is performed cyclically until the number of the currently pending task is greater than or equal to the number of the current target computing unit. The current target computing unit is a target computing unit that is idle at the current moment and has no correspondence with any currently pending task.

The “establishing the correspondence between the currently pending task and the current target computing unit” in the above step B1 specifically includes the following step B11.

In step B11, based on the optimal matching algorithm, the correspondence is established between all currently pending tasks and a corresponding number of current target computing units.

In step B2, after step B1, based on the optimal matching algorithm, the correspondence between the currently pending tasks equal in number to the current target computing units and the current target computing units is established.

In the embodiment of the present application, if the number of currently pending tasks is less than the number of current target computing units, one currently pending task is assigned to multiple current target computing units in order to make full use of all the current target computing units. That is, after the allocation, at least one target computing unit corresponds to multiple currently pending tasks. The one-to-many correspondence between the currently pending task and the current target computing unit is determined by cyclically performing the process of establishing the correspondence (i.e., cyclically performing the above step B11).

Specifically, the number of currently pending tasks is M, the number of current target computing units is N, and M<N. In this case, the “establishing the correspondence between the currently pending task and the current target computing unit” is performed for the first time, that is, step B11 is performed for the first time. A correspondence is established between the M currently pending tasks and the corresponding number of current target computing units (that is, M current target computing units). Since the correspondence has been established for these current target computing units, these computing units are no longer the current target computing units after step B11. Therefore, the number of current target computing units decreases to N−M. In this case, if the number of currently pending tasks is still smaller than the number of current target computing units, that is, M<N−M, step B11 is performed for the second time. Thereafter, the number of the current target computing units changes from N to 2M. If the number of currently pending tasks is greater than or equal to the number of current target computing units, that is, M≥N−2M, the round ends, and then step B2 is performed. If the number of currently pending tasks is still less than the number of current target computing units, that is, M<N−2M, the next round of step B11 is performed until the number of currently pending tasks is greater than or equal to the number of current target computing units. Then, step B2 is performed.

After the round, the number of currently pending tasks is greater than or equal to the number of current target computing units. Similar to the above step A1, based on the optimal matching algorithm, a correspondence between currently pending tasks corresponding to the number of current target computing units and corresponding current target computing units is established. Different from the processing result of the step A1, in step B1, all currently pending tasks each have a correspondence with the target computing unit. Therefore, based on the steps B1 to B2 according to the embodiment of the present application, the correspondence is established for all the currently pending tasks, and there is no currently pending task for which no correspondence has been established.

For example, at the initial moment, the currently pending task is the initial task, and the current target computing unit is the determined target computing unit for processing the initial task set. If the number M of initial tasks is equal to 5 and the number N of target computing units is equal to 14, the above step B11 is performed for the first time. The number of current target computing units becomes 14−5=9. In this case, the number of currently pending tasks is still smaller than the number of current target computing units, and thus the above step B11 is performed for the second time. The number of current target computing units becomes 9−5=4, and this cycle ends. Then, step B2 is performed, that is, a correspondence between four of the five initial tasks and the remaining last four target computing units is established. Finally, the four initial tasks each have a correspondence with three target computing units, and the remaining one initial task has a correspondence with two target computing units.

If the number of currently pending tasks is 1 and the number of current target computing units is multiple, the task scheduling strategy is determined from the above steps B1 to B2. However, the cycle in this case (that is, the step B11) essentially selects which current target computing unit to establish a correspondence with the currently pending task. Therefore, the process may be implemented directly based on the optimal matching algorithm. Specifically, the process of “generating a task scheduling strategy based on the currently pending task” performed by the heterogeneous computing terminal may include the following step C1.

In step C1, when the number of the currently pending task is 1, a correspondence is established between the currently pending task and each current target computing unit. The current target computing unit is a target computing unit that is idle at the current moment and has no correspondence with any currently pending task.

In the embodiment of the present application, if the number of currently pending tasks is greater than 1, the above step A1 is performed or steps B1 to B2 are performed based on the actual situation. If the number of currently pending tasks is 1, step C1 is performed. If there are multiple current target computing units, the determined correspondence between the currently pending task and the target computing units is a one-to-many correspondence.

In addition, those skilled in the art should understand that if there is no current target computing unit at the current moment, that is, the number of current target computing units is zero, then there is no available computing unit and therefore it is unnecessary to generate the task scheduling strategy. That is, the above step A1, steps B1 to B2, or step C1 are not performed.

In the embodiment of the present application, if there is a one-to-one correspondence between the target computing unit and the currently pending task, the complete currently pending task is determined as the target task of the corresponding target computing unit as described above. If there is a many-to-one correspondence between the target computing unit and the currently pending task, that is, there is a correspondence between one currently pending task and multiple target computing units, the currently pending task is divided. Specifically, the process of “generating a corresponding task scheduling strategy based on the currently pending task” performed by the heterogeneous computing terminal includes the following step D1.

In step D1, in the case that there is a correspondence between multiple target computing units and one currently pending task, the currently pending task is divided into subtasks whose number is equal to that of the multiple target computing units. The subtasks are the target tasks that the corresponding target computing unit are to process.

In the embodiment of the present application, if there is a correspondence between multiple target computing units and the same currently pending task, for example, the correspondence between the target computing units and the currently pending task determined from the steps B1 to B2 or step C1 is a many-to-one correspondence, the currently pending task is divided into subtasks has the same number as these target computing units, so that there is a one-to-one correspondence between the multiple subtasks and these target computing units. Further, these subtasks are determined as the target tasks of the corresponding target computing units. That is, the target task of the target computing unit is a part of the currently pending task. In this case, the task scheduling strategy not only includes the correspondence between the currently pending task and the target computing units, but also includes the correspondence between the subtasks divided from the currently pending task and the target computing units.

For example, there is a correspondence between a currently pending task S and n target computing units. In this case, the currently pending task S is divided into n subtasks. For example, the n subtasks are represented by s₁, s₂, . . . , sₙ, where sᵢ∈S, and S={s₁, s₂, . . . , sₙ}. In the embodiment of the present application, n subtasks s₁, s₂, . . . , sₙ are assigned to the n target computing units respectively. Each target computing unit processes a part of the currently pending task S.

Optionally, the target computing unit also has performance parameter, including the number of IP cores, power consumption, and so on. Based on the performance parameter of each target computing unit (and the features of the currently pending task, the correspondence between the currently pending task and the target computing unit is determined. For example, it is determined based on the optimal matching algorithm that a currently pending task should be assigned to a target computing unit of which performance parameter. In addition, in the embodiment of the present application, tasks are also divided based on performance parameters of the target computing unit. Specifically, the above step D1 of “dividing the currently pending task corresponding to the multiple target computing units into subtasks equal in number to the multiple target computing units” may include the following steps D11 to D14.

In step D11, the performance parameter of the target computing unit is optimized. The optimized performance parameter has a higher degree of discrimination than the unoptimized performance parameter before optimization.

In the embodiment of the present application, each computing unit has the corresponding performance parameter. For example, the performance parameter may include a clock frequency of the computing unit, the number of IP cores (intellectual property cores), power consumption, and the like. Specifically, when computing units process tasks of different categories, the performance parameters of their correspondences may also be different. Specifically, the performance parameter of the target computing unit may include the clock frequency selected by the target computing unit for processing the corresponding target task, the number of IP cores that can be stored when processing the target task, and the power consumption when processing the target task.

In the embodiment of the present application, the performance parameter of the target computing unit is used to determine a performance value of the target computing unit. Since the performance parameters of some target computing units have a relatively small difference, the original performance parameter is optimized so that the optimized performance parameter has a higher degree of discrimination in the embodiment of the present application. The performance value of the target computing unit determined based on the optimized performance parameter has more differentiated performance. That is, the performance values of different target computing units are quite different, and the computing units with different performances can be more accurately distinguished from each other.

Specifically, for example, an i-th performance parameter of a target computing unit is p_{1,i}, and the i-th performance parameter of the other target computing unit is p_{2,i}. The two performance parameters are of the same category, for example, both are the number of IP cores. If the function for optimizing performance parameters is f( ), then the optimized performance parameters are f(p_{1,i}) and f(p_{2,i}) respectively. Further, the optimized performance parameter has a higher degree of discrimination than the unoptimized performance parameter, that is |f(p_{1,i})−f(p_{2,i})|>|p_{1,i}−p_{2,i}|. The optimization (i.e., increase or decrease) of the performance parameter may be customized depending on the actual needs of the scene business, such as task urgency (self-defined priority), and low power consumption priority (that is, the weight of power consumption factors becomes larger).

In step D12, the optimized performance parameter of the target computing unit is determined as an input of a performance function model, and the performance value of the target computing unit is determined. The performance function model represents the functional relationship between the performance parameter of the computing unit and the performance value of the computing unit.

In the embodiment of the present application, the performance function model is used to represent the relationship between the performance parameter of the computing unit and its performance value. The performance function model is essentially a function. Different computing units may share the same performance function model. For example, the performance parameter of the computing unit includes the clock frequency CLK, the number IP_{NUMBER} of IP cores, power consumption W, and the like. If the performance function model is expressed as F( ), then the performance value of the computing unit may be expressed as F(CLK, IP_{NUMBER}, W, . . . ). The performance value of each target computing unit is determined based on the performance function model.

In step D13, the performance values of the multiple target computing units are normalized to determine the weight of each of the multiple target computing units in the multiple target computing units.

In step D14, the currently pending task corresponding to the multiple target computing units is divided into subtasks equal in number to the multiple target computing units according to the weights. There is a positive correlation between the processing amount of a subtask and the corresponding weight.

In the embodiment of the present application, the performance values of multiple target computing units corresponding to the same currently pending task are normalized. The normalized performance values are determined as the weights of the corresponding target computing units. Generally, the sum of the weights of these target computing units is 1, and accordingly each weight represents a proportion. The currently pending task is divided based on these weights. A great weight corresponds to more subtasks, i.e., the processing amount corresponding to the subtask is larger. There is a positive correlation between the processing amount of a subtask and the corresponding weight. For example, there is a direct proportional relationship between the processing amount of a subtask and the corresponding weight. The multiple subtasks are assigned to the corresponding target computing units.

The heterogeneous computing terminal according to the embodiment of the present application generates the corresponding task scheduling strategy based on the currently pending task and the number of current target computing units at the current moment, so that the task scheduling strategy is applicable to the scene corresponding to the current moment. Moreover, all the idle target computing units (that is, the current target computing units) can be effectively utilized, and the processing resources of the computing unit can be effectively utilized, and the processing efficiency is high. In addition, the performance value of the target computing unit determined based on its optimized performance parameter has a more clearly differentiated performance value, thereby better dividing the currently pending task.

Optionally, the absence of currently pending task at the current moment indicates that all tasks have been assigned. No task scheduling strategy is generated in this case. Alternatively, there is no currently pending task at the current moment but the initial task set has not been completely processed and there is a current target computing unit, that is, there is an idle target computing unit, a task scheduling strategy is still generated. Specifically, the heterogeneous computing terminal is also configured to perform the following step E1.

In step E1, after the target computing unit finishes processing the assigned target task, a part of the currently unfinished task of another target computing unit is determined as the task to be processed by this target computing unit if there is no currently pending task. The currently unfinished task is a task that has not been processed among the target tasks processed by another target computing unit at the current moment.

In the embodiment of the present application, after the target computing unit A finishes processing the assigned target task, for example, after the above step S206, if other target computing unit than the target computing unit A is still processing the target task assigned to itself at the current moment (that is, the moment when the target computing unit A has finished processing the assigned target task), that is, the initial task set has not been processed, some unprocessed tasks in other target computing unit may be assigned to the target computing unit A. For the convenience of description, in the embodiment of the present application, some tasks that have not been processed among the target tasks processed by another target computing unit at the current moment are referred to as “currently unfinished tasks”. The currently unfinished task is a part of the target tasks of another target computing unit. In the embodiment of the present application, a part of the currently unfinished task is assigned to the target computing unit A, as a newly target task of the target computing unit A, that is, a newly target task. The rest of the currently unfinished task is still processed by another target computing unit. When there are remaining unfinished tasks in multiple target computing units, the remaining tasks in the target computing unit with the highest complexity (for example, the largest amount of remaining processing) may be selected as the currently unfinished task.

In addition, if the newly target task assigned to the target computing unit A has a different category from the target task it processed recently, the target computing unit A also acquires the upgrade program corresponding to the newly target task and is upgraded, so that the target computing unit A can process the newly target task.

Optionally, allocating the currently unfinished task in the above step E1 is essentially dividing the currently unfinished task. Similar to the above steps D11 to D14, the above step E1 of “determining a part of the currently unfinished task in other target computing unit as a newly target task of the target computing unit that finishes the processing” may specifically include the following steps E11 to E12.

In step E11, the performance values of other target computing units and n target computing units that finish the processing are normalized to determine weights of other target computing units and the n target computing units.

In the embodiment of the present application, the performance value of the target computing unit may be constant. In this case, the determination of the performance value of the target computing unit is only performed once, for example, the above steps D1 to D12 are performed once. Alternatively, if the performance parameter of the target computing unit is related to the category of the target task to be processed, the performance value of the target computing unit is determined every time the target computing unit is upgraded. After the performance value of the target computing unit is determined, the performance values of the n target computing units and other target computing unit corresponding to the currently unfinished task (a total of n+1 target computing units) are normalizes, so as to determine the weights of the n+1 target computing units.

In step E12, the currently unfinished task is divided into n+1 subtasks based on the weights of other target computing unit and n target computing units, as newly target tasks of the target computing units that finish the processing. There is a positive correlation between the processing amount of the subtasks obtained by dividing the currently unfinished task and the corresponding weights.

Similar to step D14 above, the currently unfinished task is divided into n+1 subtasks based on the weights of the n+1 target computing units. Each subtask corresponds to a corresponding weight, and also corresponds to a corresponding target computing unit. Furthermore, n subtasks are assigned to corresponding target computing units that finish the processing, and the other one subtask is still processed by the other target computing unit.

In the embodiment of the present application, after the target computing unit finishes processing, unfinished tasks to be processed by other target computing unit, that is, a part of the currently unfinished task, are stilled assigned to this target computing unit. Therefore, multiple target computing units process the currently unfinished task, thereby further improving the utilization of the computing units and improving the processing efficiency.

In addition, optionally, the heterogeneous computing terminal according to the embodiment of the present application may also be applicable to situations such as task interruption and other task changes. Specifically, the heterogeneous computing terminal (for example, the processing unit or task scheduling system) is further configured to send an interrupt signal to the target computing unit when receiving a task change instruction for changing the initial task set. In response to the interrupt signal, the target computing unit still processes the target task until part or all of the target task is completely processed, and sends a processing completion signal. The heterogeneous computing terminal newly generates a task scheduling strategy in response to the processing completion signal.

In the embodiment of the present application, the heterogeneous computing terminal interrupts the task processing when receiving the task change instruction. For example, the task change instruction may indicate an addition of new task, a reduction of task, or interruption of task. For example, when receiving the task change instruction, the processing unit notifies the task scheduling system to be on standby, and sends the interrupt signal to the computing unit. The interrupt signal may be sent to all the target computing units, or some related target computing units, which is not limited herein.

If the target computing unit stops processing immediately after receiving the interrupt signal, it is likely to cause abnormal task processing. In the embodiment of the present application, after receiving the interrupt signal, the target computing unit still processes the target task instead of stopping processing immediately until part or all of the target task is completely processed. For example, the target tasks assigned to the target computing unit are multiple sets of data. If the target computing unit has processed a certain set of data and is about to process the next set of data, it can be considered that the target computing unit has completely processed a part of the target task. Correspondingly, if receiving the interrupt signal when a certain set of data is currently being processed, the target computing unit still processes the set of data until the set of data is processed completely.

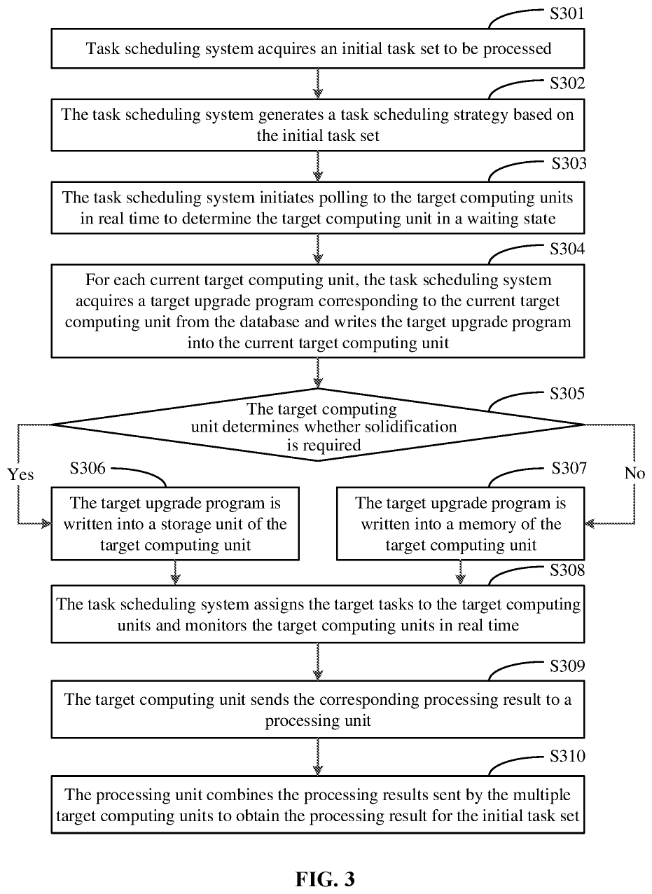

The following describes the operation of the heterogeneous computing terminal in detail through an embodiment. Referring to FIG. 3, the operation of the heterogeneous computing terminal specifically includes the following steps S301 to S310.

In step S301, the task scheduling system acquires an initial task set to be processed.

In step S302, the task scheduling system generates a task scheduling strategy based on the initial task set.

In step S303, the task scheduling system initiates polling to the target computing units in real time to determine the target computing unit in a waiting state.

The target computing unit in the waiting state is the current target computing unit, that is, is currently idle and has no correspondence with any task.

In step S304, for each current target computing unit, the task scheduling system acquires a target upgrade program corresponding to the current target computing unit from the database and writes the target upgrade program into the current target computing unit.

In step S305, the target computing unit determines whether solidification is required. If solidification is required, step S306 is performed. Otherwise, step S307 is performed.

In step S306, the target upgrade program is written into a storage unit of the target computing unit, and then step S308 is performed.

In step S307, the target upgrade program is written into a memory of the target computing unit, and then step S308 is performed.

In step S308, the task scheduling system assigns the target tasks to the target computing units and monitors the target computing units in real time.

The task scheduling system monitors in real time whether there is a current target computing unit, whether there is a currently pending task, whether there is a target computing unit that has completed processing, and so on.

In step S309, the target computing unit sends the corresponding processing result to the processing unit.

In step S310, the processing unit combines the processing results sent by the multiple target computing units to obtain the processing result for the initial task set.

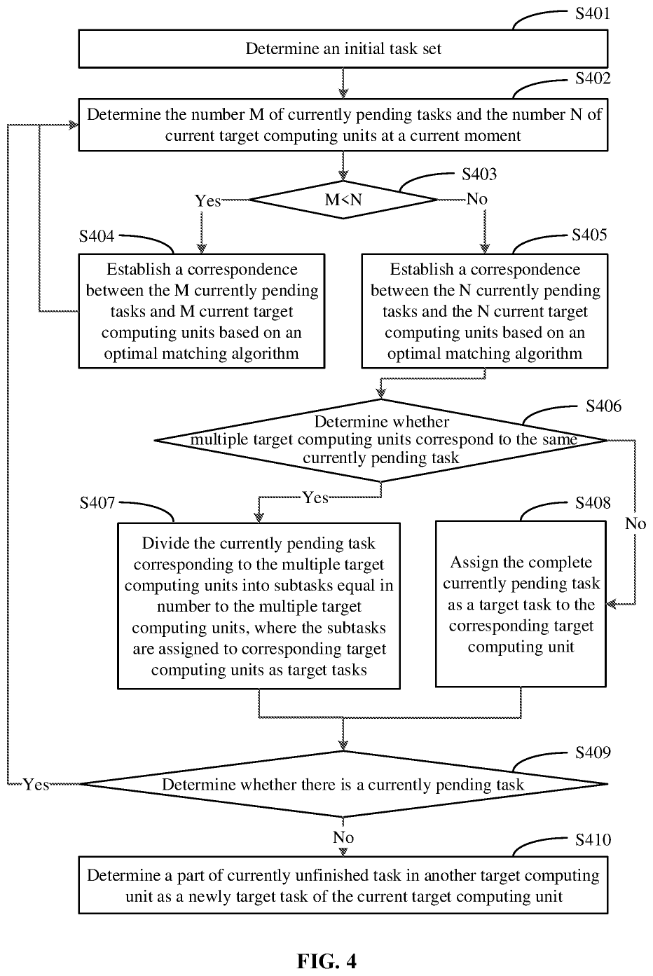

The task scheduling system generates a task scheduling strategy including the currently pending task and the current target computing unit in real time based on the situation at the current moment, for example, in the above step S302 or the above step S308. Specifically, referring to FIG. 4, the generation of the task scheduling strategy specifically includes the following steps S401 to S410.

In step S401, an initial task set is determined.

In step S402, the number M of currently pending tasks and the number N of current target computing units at the current moment are determined.

At the initial moment when the initial task set is acquired, that is, the current moment, the number of currently pending tasks is the number of initial tasks, and the number of current target computing units is the number of all target computing units. At another current moment, M and N depend on the actual situation. The number N of the current target computing unit is not equal to 0. If N is equal to 0, the process of generating the task scheduling strategy is not performed, that is, the subsequent steps are not performed.

In step S403, it is determined whether M is smaller than N. If M is smaller than N, step S404 is performed. Otherwise, step S405 is performed.

In step S404, based on the optimal matching algorithm, a correspondence between the M currently pending tasks and M current target computing units is established. Then, step S402 is performed.

In step S405, based on the optimal matching algorithm, a correspondence between the N currently pending tasks and the N current target computing units is established. Then, S406 is performed.

In the embodiment of the present application, if the number M of the currently pending tasks is less than the number N of the current target computing units, the above step B11 is performed. That is, as shown in step S404, the correspondence between M (i.e., all) currently pending tasks and M current target computing units is established. In this case, there are still N−M current target computing units, and the above step S402 is performed again, thereby forming a cycle.

If the number M of currently pending tasks is greater than or equal to the number N of current target computing units, that is, M is greater than or equal to N, for example, the number of initial tasks is greater than the number of all the target computing units, step S405 is performed. That is, each current target computing unit is assigned a currently pending task. In this case, the step S405 is similar to the above step A1. Alternatively, after step S404 is performed one or more times, the number N of current target computing units may change. If the number N of the current target computing units is less than or equal to the number M of the currently pending tasks, step S405 is also performed. In this case, the step S405 is similar to the above step B2.

In step S406, it is determined whether multiple target computing units correspond to the same currently pending task. If it is determined that there are multiple target computing units corresponding to the same currently pending task, step S407 is performed. Otherwise, step S408 is performed.

In step S407, the currently pending task corresponding to the multiple target computing units is divided into subtasks equal in number to the multiple target computing units. The subtasks are assigned to corresponding target computing units, as target tasks.

In the embodiment of the present application, if multiple target computing units correspond to the same currently pending task, the currently pending task is divided, for example, based on the above steps D11 to D14.

Optionally, before (or after) step S403 above, it is determined whether the number of currently pending tasks is 1, that is, whether M is equal to 1. M equal to 1 means that only one task is to be processed currently. For example, the initial task set includes only one initial task. In this case, the task is directly divided, that is, step S407 is directly performed.

In step S408, the complete currently pending task is assigned as a target task to the corresponding target computing unit.

In the embodiment of the present application, if the number of initial tasks in the initial task set is greater than the number of target computing units, a one-to-one correspondence is established between the target computing units and the initial tasks. In this case, there is no situation where multiple target computing units correspond to the same initial task. Therefore, the complete currently pending task is assigned to the corresponding target computing unit as the target task.

Moreover, after steps S407 and S408, the target computing unit processes the corresponding target task, and sends the corresponding processing result to the processing unit after the processing is completed.

In step S409, if there is a current target computing unit, it is determined whether there is a currently pending task. If there is a currently pending task, step S402 is performed. Otherwise, step S410 is performed.

In step S410, if the initial task set has not been processed completely, a part of currently unfinished task in another target computing unit is determined as a newly target task of the current target computing unit.

In the embodiment of the present application, after step S407 or S408, if there is still a current target computing unit, it means that one or some target computing units have completed processing the previously assigned target tasks. The current target computing unit in this case is also the target computing unit that has completed processing. In this case, if there is still a currently pending task, step S402 is performed again to establish a correspondence between the currently pending task and the current target computing unit. For example, if the number M of initial tasks in the initial task set is greater than the number N of target computing units, there are still M−N initial tasks that have not been processed after the above steps S405 and S408 are performed once. These M−N initial tasks are still currently pending tasks. In this case, step S402 is performed again, that is, the task scheduling strategy is generated again based on the M-N initial tasks as a new initial task set.

If there is no currently pending task, all initial tasks are assigned to corresponding target computing units for processing. In this case, however, there is an available target computing unit, that is, the current target computing unit. If other target computing units have not finished processing, that is, there is a currently unfinished task, a part of the currently unfinished task is assigned to the current target computing unit as shown in step S410 above. The above steps S401 to S410 are repeated until the initial task set is processed completely.

According to the heterogeneous computing terminal in the embodiments of the present application, various upgrade programs for processing correspondingly category of tasks can be preset for the computing unit. The upgrade program is matched to the category of tasks to be processed. In order to process the initial task set, the heterogeneous computing terminal generates a task scheduling strategy, and assigns the target tasks to be processed to the corresponding target computing units. The target computing unit can be upgraded based on the corresponding target upgrading program, so that the upgraded target computing unit can process the assigned target tasks, thereby achieving task scheduling and processing. The heterogeneous computing terminal can upgrade the computing unit online, that is, dynamically update the computing unit, thereby greatly expanding the versatility of the computing unit of the hardware. The scheduling strategy adapted to the task can be generated, and the computing unit can dynamically provide better task processing capabilities. In this way, the computing efficiency of the heterogeneous computing terminal is improved, and the heterogeneous computing terminal is suitable for scenarios with high latency requirements. Further, the heterogeneous computing terminal also has better processing capability and processing efficiency when facing complex tasks.

The heterogeneous computing terminal according to the embodiment of the present application generates the corresponding task scheduling strategy based on the currently pending task and the number of current target computing units at the current moment, so that the task scheduling strategy is applicable to the scene corresponding to the current moment. Moreover, all the idle target computing units (that is, the current target computing units) can be effectively utilized, and the processing resources of the computing unit can be effectively utilized, and the processing efficiency is high. In addition, the performance value of the target computing unit determined based on its optimized performance parameter has a more clearly differentiated performance value, thereby better dividing the currently pending task. In addition, after the target computing unit finishes processing, unfinished tasks to be processed by other target computing unit, that is, a part of the currently unfinished task, are stilled assigned to this target computing unit. Therefore, multiple target computing units process the currently unfinished task, thereby further improving the utilization of the computing units and improving the processing efficiency.

Only the specific implementation of the embodiments of the present application is described above. However, the protection scope of the embodiments of the present application is not limited thereto. Any changes or substitutions that can be readily conceived by those skilled in the art within the technical scope disclosed in the embodiments of the present application shall fall within the protection scope of the embodiments of the present application. Therefore, the protection scope of the embodiments of the present application should be determined by the protection scope of the claims.

1. A heterogeneous computing terminal for task scheduling, comprising: a processing unit and a plurality of computing units, wherein
the heterogeneous computing terminal is configured to acquire an initial task set comprising at least one initial task, and generate a task scheduling strategy based on a currently pending task, wherein the currently pending task is a task to be processed at a current moment, and at an initial moment the initial task is the currently pending task; and the task scheduling strategy comprises a correspondence between the currently pending task and a target computing unit, and the target computing unit is a computing unit for processing the initial task set;
the target computing unit is configured to acquire a target upgrade program corresponding to the currently pending task that has the correspondence with the target computing unit from a preset database, and to be upgrade based on the target upgrade program, wherein for each of the plurality of computing units, the database comprises an upgrade program corresponding to the computing unit; and the computing unit corresponds to a plurality of upgrade programs each corresponding to a category of tasks that the computing unit is to process;
the target computing unit is further configured to acquire a target task to be processed, process the target task after the upgrade, and send a corresponding processing result to the processing unit; and
the processing unit is configured to combine processing results sent by a plurality of target computing units to obtain a processing result of the initial task set.

2. The heterogeneous computing terminal according to claim 1, wherein the generation of the task scheduling strategy based on the currently pending task comprises:
establishing a correspondence between currently pending tasks equal in number to current target computing units and the current target computing units based on an optimal matching algorithm, in a case that the number of the currently pending tasks is greater than or equal to the number of the current target computing units, wherein the current target computing unit is a target computing unit that is idle at the current moment and has no correspondence with any of currently pending task.

3. The heterogeneous computing terminal according to claim 2, wherein
the heterogeneous computing terminal is further configured to: determine a part of a currently unfinished task in other target computing unit as a newly target task of the target computing unit after finishing processing the assigned target task, wherein the currently unfinished task is a task that has not been processed among target tasks processed by the other target computing unit at the current moment.

4. The heterogeneous computing terminal according to claim 3, wherein the determination of the part of the currently unfinished task in another target computing unit as the newly target task of the target computing unit comprises:
normalizing performance values of the other target computing unit and n target computing units that have finished processing to determine weights of the other target computing unit and the n target computing units; and
dividing the currently unfinished task into n+1 subtasks based on the weights of the other target computing unit and the n target computing units, as newly target tasks of the target computing units that have finished processing, wherein processing amount of the subtask has a positive correlation with the corresponding weight.

5. The heterogeneous computing terminal according to claim 1, wherein the generation of the task scheduling strategy based on the currently pending task comprises:
establishing a correspondence between currently pending tasks and current target computing units repeatedly until the number of the currently pending tasks is greater than or equal to the number of the current target computing units, in a case that the number of the currently pending tasks is less than the number of the current target computing units, wherein the current target computing unit is a target computing unit that is idle at the current moment and has no correspondence with any of the currently pending tasks; and
establishing the correspondence between the currently pending tasks equal in number to the current target computing units and the current target computing units based on an optimal matching algorithm, wherein the establishing a correspondence between currently pending tasks and current target computing units comprises:
establishing the correspondence between all the currently pending tasks and the current target computing units equal in number to all the currently pending tasks.

6. The heterogeneous computing terminal according to claim 5, wherein
the heterogeneous computing terminal is further configured to: determine a part of a currently unfinished task in other target computing unit as a newly target task of the target computing unit after finishing processing the assigned target task, wherein the currently unfinished task is a task that has not been processed among target tasks processed by the other target computing unit at the current moment.

7. The heterogeneous computing terminal according to claim 6, wherein the determination of the part of the currently unfinished task in another target computing unit as the newly target task of the target computing unit comprises:
normalizing performance values of the other target computing unit and n target computing units that have finished processing to determine weights of the other target computing unit and the n target computing units; and
dividing the currently unfinished task into n+1 subtasks based on the weights of the other target computing unit and the n target computing units, as newly target tasks of the target computing units that have finished processing, wherein processing amount of the subtask has a positive correlation with the corresponding weight.

8. The heterogeneous computing terminal according to claim 1, wherein the generation of the task scheduling strategy based on the currently pending task comprises:
establishing a correspondence between the currently pending task and each current target computing unit in a case that the currently pending task is 1 in number, wherein the current target computing unit is a target computing unit that is idle at the current moment and has no correspondence with any currently pending task.

9. The heterogeneous computing terminal according to claim 8, wherein
the heterogeneous computing terminal is further configured to: determine a part of a currently unfinished task in other target computing unit as a newly target task of the target computing unit after finishing processing the assigned target task, wherein the currently unfinished task is a task that has not been processed among target tasks processed by the other target computing unit at the current moment.

10. The heterogeneous computing terminal according to claim 9, wherein the determination of the part of the currently unfinished task in another target computing unit as the newly target task of the target computing unit comprises:
normalizing performance values of the other target computing unit and n target computing units that have finished processing to determine weights of the other target computing unit and the n target computing units; and
dividing the currently unfinished task into n+1 subtasks based on the weights of the other target computing unit and the n target computing units, as newly target tasks of the target computing units that have finished processing, wherein processing amount of the subtask has a positive correlation with the corresponding weight.

11. The heterogeneous computing terminal according to claim 1, wherein the generation of the task scheduling strategy based on the currently pending task comprises:
in a case that the plurality of target computing units correspond to the same currently pending task, dividing the currently pending task into subtasks equal in number to the plurality of target computing units, wherein the subtask is the target task to be processed by the corresponding target computing unit.

12. The heterogeneous computing terminal according to claim 11, wherein
the heterogeneous computing terminal is further configured to: determine a part of a currently unfinished task in other target computing unit as a newly target task of the target computing unit after finishing processing the assigned target task, wherein the currently unfinished task is a task that has not been processed among target tasks processed by the other target computing unit at the current moment.

13. The heterogeneous computing terminal according to claim 12, wherein the determination of the part of the currently unfinished task in another target computing unit as the newly target task of the target computing unit comprises:
normalizing performance values of the other target computing unit and n target computing units that have finished processing to determine weights of the other target computing unit and the n target computing units; and
dividing the currently unfinished task into n+1 subtasks based on the weights of the other target computing unit and the n target computing units, as newly target tasks of the target computing units that have finished processing, wherein processing amount of the subtask has a positive correlation with the corresponding weight.

14. The heterogeneous computing terminal according to claim 11, wherein the division of the currently pending task into subtasks equal in number to the plurality of target computing units comprises:
optimizing performance parameters of the plurality of target computing units, wherein the optimized performance parameters have a higher degree of discrimination than the unoptimized performance parameters;
determining performance values of the plurality of target computing units with the optimized performance parameters of the target computing units as an input of a performance function model, wherein the performance function model represents a functional relationship between the performance parameter of the computing unit and the performance value of the computing unit;
normalizing the performance values of the plurality of target computing units to determine weights of the plurality of target computing units; and
dividing the currently pending task into subtasks equal to the number of the plurality of target computing units based on the weights, wherein processing amount of the subtask has a positive correlation with the corresponding weight.

15. The heterogeneous computing terminal according to claim 14, wherein
the heterogeneous computing terminal is further configured to: determine a part of a currently unfinished task in other target computing unit as a newly target task of the target computing unit after finishing processing the assigned target task, wherein the currently unfinished task is a task that has not been processed among target tasks processed by the other target computing unit at the current moment.

16. The heterogeneous computing terminal according to claim 15, wherein the determination of the part of the currently unfinished task in another target computing unit as the newly target task of the target computing unit comprises:
normalizing performance values of the other target computing unit and n target computing units that have finished processing to determine weights of the other target computing unit and the n target computing units; and
dividing the currently unfinished task into n+1 subtasks based on the weights of the other target computing unit and the n target computing units, as newly target tasks of the target computing units that have finished processing, wherein processing amount of the subtask has a positive correlation with the corresponding weight.

17. The heterogeneous computing terminal according to claim 1, wherein
the heterogeneous computing terminal is further configured to: determine a part of a currently unfinished task in other target computing unit as a newly target task of the target computing unit after finishing processing the assigned target task, wherein the currently unfinished task is a task that has not been processed among target tasks processed by the other target computing unit at the current moment.

18. The heterogeneous computing terminal according to claim 17, wherein the determination of the part of the currently unfinished task in another target computing unit as the newly target task of the target computing unit comprises:
normalizing performance values of the other target computing unit and n target computing units that have finished processing to determine weights of the other target computing unit and the n target computing units; and
dividing the currently unfinished task into n+1 subtasks based on the weights of the other target computing unit and the n target computing units, as newly target tasks of the target computing units that have finished processing, wherein processing amount of the subtask has a positive correlation with the corresponding weight.

19. The heterogeneous computing terminal according to claim 1, wherein the target computing unit is further configured to:
determine whether the target upgrade program is to be solidified;
write the target upgrade program into a storage unit of the target computing unit if the target upgrade program is to be solidified; and
write the target upgrade program into a memory of the target computing unit if the target upgrade program is not to be solidified.

20. The heterogeneous computing terminal according to claim 1, wherein
the heterogeneous computing terminal is further configured to send an interrupt signal to the target computing unit when receiving a task change instruction for changing the initial task set;
the target computing unit is further configured to still process the target task until part or all of the target task is completely processed, and send a processing completion signal; and
the heterogeneous computing terminal is further configured to newly generate a task scheduling strategy in response to the processing completion signal.
